(19) United States
(12) Patent Application Publication
(10) Pub. No.: US 2003/0142305 A1
(43) Pub. Date: Jul. 31, 2003

(54) Spectrophotometer

(75) Inventor: Hajime Bungo, Muko-shi (JP)

Correspondence Address: KANESAKA AND TAKEUCHI, 1423 Powhatan Street, Suite 2, Alexandria, VA, 22314, US

(73) Assignee: SHIMADZU CORPORATION

(21) Appl. No.: 10/340,681

(22) Filed: Jan. 13, 2003

(30) Foreign Application Priority Data
Jan. 29, 2002 (JP) 2002-019321

(51) Int. Cl. G01J 3/42

(52) U.S. Cl. 356/319

(57) ABSTRACT

In a spectrophotometer, a photodiode detects light transmitted through a sample in a cell. A pre-amplifier and a feedback resistance are connected to the photodiode to convert a small electric current from the photodiode and amplify a voltage thereof. The voltage is read at a CPU after converted to a digital signal at an A/D converter. A sample component is determined from information based on the signal in the CPU. The spectrophotometer includes a circuit for changing the feedback resistance so that the feedback resistance can be adjusted according to the input voltage to the A/D converter.

### BACKGROUND OF THE INVENTION RELATED ART STATEMENT

This invention relates to a spectrophotometer for detecting a component in a sample by irradiating light to the sample in a cell. This type of spectrophotometer is ordinarily used alone, or used as a detector for a liquid chromatograph or the like.

In a conventional spectrophotometer used as a detector for a liquid chromatograph, when a sample separated in a column passes through a cell together with a solvent, a light beam is irradiated to the cell, thereby determining a concentration of a component in the sample from an absorbance or a refraction index is of the light. Normally, a photodiode is used as a detecting device. A small electric current from the photodiode is converted into a voltage and amplified via a preamplifier and a feedback resistance. Then, a CPU reads the voltage passing through the A/D converter, and the concentration of the component is determined from information based on a signal at the CPU.

In the conventional spectrophotometer, a value (gain) of the feedback resistance is fixed. Normally, a resistivity of the resistance is selected according to the highest light intensity. When a D2 lamp is used as the light source, a light intensity of a wavelength around 700 nm is reduced to about 1/100 of that of a wavelength around 230 nm where the light intensity becomes the highest. Therefore, in a wavelength area where the light intensity becomes extremely small, a voltage converted and amplified by the pre-amplifier and the feedback resistance becomes also extremely small. Therefore, a resolution of the A/D converter is lowered, so that it is difficult to perform analysis of a sample with high sensitivity from the information based on the detection signal read at the CPU.

In view of the above problems, the present invention has been made and an object of the invention is to provide a spectrophotometer, wherein the A/D converter can maintain a high resolution over the whole wavelength area and an analysis with a high sensitivity can be carried out.

Further objects and advantages of the invention will be apparent from the following description of the invention.

### SUMMARY OF THE INVENTION

In order to attain the above object, in a spectrophotometer, a photodiode detects light transmitted through a sample in a cell. A pre-amplifier and a feedback resistance are used to convert a small electric current from the photodiode to a voltage and amplify. The voltage is read at a CPU through an A/D converter. A sample component is detected from information based on the signal at the CPU. The present invention includes a circuit for changing the feedback resistance so that the feedback resistance can be adjusted according to the input voltage to the A/D converter.

The feedback resistance is selected according to the voltage input to the A/D converter by the CPU. More specifically, the CPU stores a threshold value (reference voltage) as a proper voltage input to the A/D converter. The CPU reads an output voltage from the A/D converter and compares the output voltage with the threshold value. In order to obtain the proper voltage input to the A/D converter, the CPU switches the feedback resistance among several resistances installed in advance through an analog switch or the like. Thus, an object of the present invention can be easily attained.

### BRIEF DESCRIPTION OF THE DRAWINGS

FIG. 1 is a block diagram showing a spectrophotometer of an embodiment according to the present invention; and

FIG. 2 is a flow chart for changing a feedback resistance of the spectrophotometer of the embodiment according to the present invention.

### DETAILED DESCRIPTION OF PREFERRED EMBODIMENTS

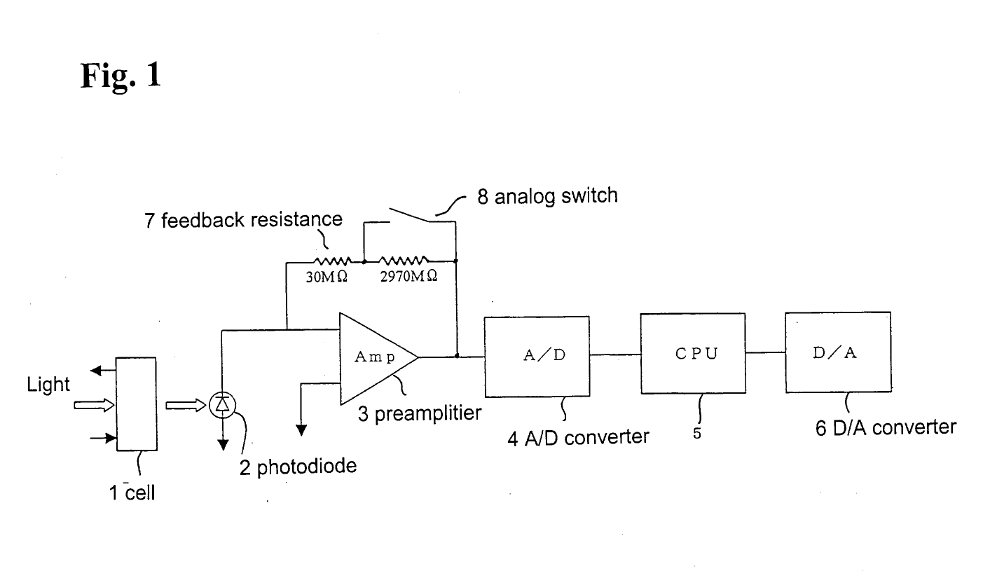

FIG. 1 is a block diagram showing an embodiment of a spectrophotometer according to the present invention. A light source lamp (not shown) irradiates light as a light beam to a cell 1 through a known spectrometer system. The cell 1 is a flow cell, in which an inlet of a channel of the cell is connected to a separation column of a liquid chromatograph and an outlet thereof is connected to a drain.

The transmitted light from the cell 1 is detected by a photodiode 2. A detected signal (a photoelectric current) from the photodiode 2 is converted to a voltage and amplified by a preamplifier 3 and a feedback resistance 7. The voltage is converted to a digital signal through an A/D converter 4, and read at a CPU 5. Accordingly, a sample component is detected at the CPU 5 from information based on the signal thereof.

The output signal processed at the CPU 5 is converted into an analog signal at a D/A converter 6. A recorder (not shown) outputs an absorption spectrum. The feedback resistance (a gain resistance) 7 in the preamplifier 3 is structured such that, for example, 30 MΩ and 2970 MΩ resistances are connected in series and the 2970 MΩ resistance can be short-circuited by an analog switch 8, thereby constituting a two-stage switching circuit of 30 MΩ and 3000 MΩ (30 MΩ+2970 MΩ) shown in FIG. 1. However, this example is only for explanation purpose. It is possible to constitute the circuit structure as a multi-stage feedback resistance in which a plurality of resistances having different resistivity, which can be switched by an analog switch or the like, may be connected in parallel.

For example, when a D2 lamp is used as the light source lamp, a photo current in the order of 60 nA is output from the photodiode 2 through a photo-effect in a wavelength 230 nm where a light intensity becomes maximum. In case that an input voltage range of the A/D converter 4 is 0 to 2.5 V, the analog switch 8 is normally closed to short-circuit the 2970 MΩ resistance. Therefore, only the 30 MΩ resistance is used as the feedback resistance 7 to control the output voltage of the preamplifier 3, so that an input voltage to the A/D converter 4 becomes 1.8 V (60 nA×30 MΩ) . Conventionally, the feedback resistance (30 MΩ) has been fixed. Therefore, in the light intensity around a wavelength 700 nm, which is reduced to about 1/100 of that of the wavelength 230 nm, the output voltage from the preamplifier 3, i.e. the input voltage to the A/D converter 4, is also reduced to 1.8 mV (60 nA×1/100×30 MΩ), thereby extremely reducing the resolution of the A/D converter 4.

Therefore, for example, the CPU 5 stores therein a threshold value (a reference voltage) corresponding to 1.8 V as a proper input voltage level with respect to the A/D converter 4. The CPU 5 reads an output voltage from the A/D converter 4 and compares the output voltage with the threshold value. Then, the CPU 5 switches the feedback resistance 7 so that the output voltage of the preamplifier 3 is within the proper input level to the A/D converter 4. More specifically, in the above embodiment, since 1.8 mV is smaller than 1.8 V, the CPU 5 generates a command for switching the feedback resistance 7, and opens the analog switch 8 to change the feedback resistance 7 to 3000 MΩ (30 MΩ+2970 MΩ) Thus, the output voltage from the preamplifier 3 becomes 1.8 V (60 nA×1/100×3000 MΩ), thereby obtaining the proper input voltage level for the A/D converter 4.

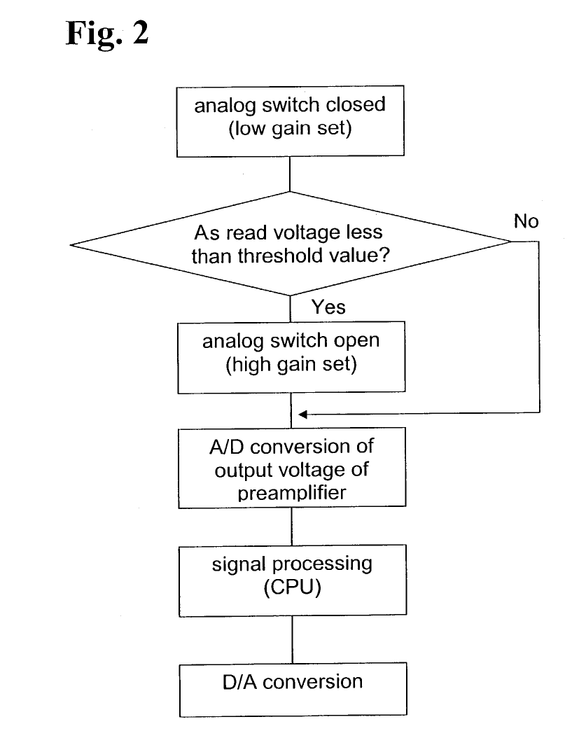

FIG. 2 is a flow chart showing an operation of switching the feedback resistance 7 in the present embodiment.

First, the analog switch 8 is closed to short the 2970 MΩ resistance, and the 30 MΩ resistance (low gain) is selected as the feedback resistance 7. Under this state, the photo current from the photodiode 2 is converted to the voltage and amplified by the preamplifier 3 and the feedback resistance 7. The CPU 5 reads the voltage through the A/D converter 4, and compares the voltage with the threshold value (the reference voltage) stored therein. In the case that the voltage is larger than the threshold value (no), the input voltage from the photodiode 2 is converted to a digital signal as it is, then processed at the CPU 5, followed by the D/A conversion.

On the other hand, in case that the voltage is smaller than the threshold value (yes), the analog switch 8 is opened to shift the feedback resistance 7 to 3000 MΩ (high gain). The CPU 5 reads the voltage through the A/D converter 4, and a sample component is detected from the information based on the signal. Thereafter, the output signal processed at the CPU 5 is converted to an analog signal at the D/A converter 6 to output an absorption spectrum thereof.

In the above embodiment, two resistances (values) are provided as the feedback resistance and the analog switch switches the two resistances in two stages. However, the present invention is not limited thereto, and it is possible to employ a multi-stage switching circuit structure wherein a plurality of resistances having different values is connected in parallel, and the analog switch switches the resistances as a group of the feedback resistances.

Also, the light source lamp is not limited to the light source covering the visible and ultraviolet light area such as the D2 lamp. It is possible to apply to a detector other than an ultraviolet detector. Further, in addition to the case where the light intensity is reduced based on the wavelength area, it is also applied to a case where a light intensity is changed based on a length of an optical path, such as a cell length.

Furthermore, in the above embodiment, the present invention is applied to the detector of the liquid chromatograph. However, the present invention is not limited thereto and can be also applied to a whole variety of spectrophotometers.

Since the present invention is structured as described above, when the signal detected by the photodiode is subjected to the A/D conversion, the input voltage to the A/D converter is always held at a proper level with a high resolution over the whole wavelengths to thereby carry out a quantitative analysis of a sample concentration or the like at a high sensitivity.

While the invention has been explained with reference to the specific embodiments of the invention, the explanation is illustrative and the invention is limited only by the appended claims.

What is claimed is:

1. A spectrophotometer, comprising
a photodiode for detecting light transmitted through a sample in a cell to produce an electric current,
a pre-amplifier and a feedback resistance, which are connected to the photodiode to convert the electric current from the photodiode to a voltage;
an A/D converter connected to the pre-amplifier and the feedback resistance for converting the voltage to a digital signal;
a CPU connected to the A/D converter for reading the digital signal to identify a sample component; and
a circuit connected to the feedback resistance for changing a resistivity of the feedback resistance according to the voltage input to the A/D converter.

2. A spectrophotometer according to claim 1, wherein said feedback resistance is formed of a plurality of resistances.

3. A spectrophotometer according to claim 2, wherein said circuit includes a switching connected to the plurality of the resistances to change the resistivity of the feedback resistance.

4. A spectrophotometer according to claim 1, wherein said CPU includes a memory for storing a threshold value and compares the voltage input to the A/D converter with the threshold value to thereby control the circuit to change the resistivity so that a value input to the A/D converter is above a predetermined value.
